(19) United States
(12) Patent Application Publication
(10) Pub. No.: US 2013/0243343 A1
(43) Pub. Date: Sep. 19, 2013

(54) METHOD AND DEVICE FOR PEOPLE GROUP DETECTION

(71) Applicant: NEC (CHINA) CO., LTD., Beijing (CN)

(72) Inventors: Hongming Zhang, Beijing (CN); Guoyi Liu, Beijing (CN); Shaopeng Tang, Beijing (CN); Feng Wang, Beijing (CN); Wei Zeng, Beijing (CN)

(73) Assignee: NEC (China) Co., Ltd., Beijing (CN)

(21) Appl. No.: 13/742,974

(22) Filed: Jan. 16, 2013

(30) Foreign Application Priority Data
Mar. 16, 2012 (CN) CN201210071625.8

(51) Int. Cl. G06K 9/00

(52) U.S. Cl. CPC G06K 9/00362
USPC 382/225

(57) ABSTRACT

A method and a device for people group detection, relating to the field of image processing includes acquiring at least one corner and foreground region in video data; computing, according to said corner and foreground region, to obtain at least one cluster; constructing at least one region of people group according to said cluster. The device includes an acquisition module, a clustering module, and a construction module. Automatic people group detection is realized that is independent of the location detection of people and can be applied to any scene including complicated ones, and thus user demands can be better satisfied.

### TECHNICAL FIELD

The present invention relates to the field of image processing, and more particularly, to a method and a device for people group detection.

### BACKGROUND OF THE INVENTION

In recent years, China's video surveillance market has developed and expanded rapidly due to the powerful stimulation and promotion of the “Peaceful City” Project, Beijing Olympic Security Project, Shanghai World Expo, Guangzhou Asian Games, and the rapid growth of the demand for security projects in various places and industries. Along with the rapid development of the market, various surveillance cameras and storage devices are becoming more and more popular and therefore a large amount of image and video data can be obtained. To analyze the data quickly and intelligently has become an urgent need of public administration and industry. IVS (Intelligent Video Surveillance) provides very important technical approaches to the analysis of the intelligent data, wherein people group detection is counted as an important monitoring analysis method of IVS.

The process of people group detection comprises: in a given monitoring region, acquiring scene video data by a camera as an input, detecting if a people group exists in a certain area; and if so, locating the people group. This technology is widely applied in the field of intelligent video surveillance, such as the security of squares in cities, the crowd control in commercial regions, and the security of railway stations.

The people group detection technology in the prior art is as follows: first, in a given monitoring region, acquiring the location of a single person by moving object extraction technology, object detection or tracking technology; then, counting the number of people based on the location of the single person; and finally, determining if the people group exists according to whether the counted number of people reaches a designated value.

However, the result of the people group detection in the method mentioned above completely depends on the location detection of people, which limits the application of this method; in particular, when the size of the human body image is very small or the scene is too complicated, it is difficult to automatically and accurately detect and locate the people by this method, therefore people group detection cannot proceed automatically, and eventually the demands in actual application cannot be met.

### BRIEF SUMMARY OF THE INVENTION

To solve the existing technical problems, a method and a device for people group detection are provided in the embodiments of the present invention. The technical solutions are as follows:

One objective of the embodiments of the present invention is to provide a method for people group detection, comprising:

acquiring at least one corner and foreground region in video data;

computing, according to said corner and foreground region, to obtain at least one cluster;

constructing at least one region of people group according to said cluster.

In one embodiment, said computing according to said corner and foreground region to obtain at least one cluster comprises:

acquiring the intersection of the pixels in said corner and said foreground region to obtain a corner set;

performing a clustering operation on said corner set by using a clustering algorithm to obtain at least one cluster.

In another embodiment, constructing at least one region of people group according to said cluster comprises:

constructing a region of people group for each obtained cluster by taking the cluster center as the center, and said region is a region containing the corners in said cluster.

In another embodiment, the region of people group constructed for each cluster is specifically the minimal region containing all the corners in said cluster, said corner is a pixel with local structural characteristics in an image.

In another embodiment, after constructing at least one region of people group according to said cluster, said method further comprises:

computing the size of said region of people group, filtering said region of people group according to the size of said region of people group; or

computing the corner density of said region of people group, filtering said region of people group according to said corner density.

Preferably, filtering said region of people group according to the size of said region of people group comprises:

for each constructed region of people group, filtering out said region if the size of said region is smaller than a preset first threshold value.

Preferably, filtering said region of people group according to said corner density comprises:

for each constructed region of people group, filtering out said region if the corner density of said region is smaller than a preset second threshold value.

Furthermore, before filtering said region of people group according to said corner density, said method further comprises:

acquiring at least one positive sample region of people group and at least one negative sample region of people group in the manually marked sample data;

computing the corner density of said positive sample region and the corner density of said negative sample region;

computing the first distribution graph of the corner density of said positive sample region and the second distribution graph of the corner density of said negative sample region;

acquiring the corner density value corresponding to the intersection point of said first distribution graph and said second distribution graph;

defining said acquired corner density value as said second threshold value.

In another embodiment, after constructing at least one region of people group according to said cluster, said method further comprises:

computing the optical flow magnitude of the designated pixels in said region of people group;

computing the density of optical flow magnitude of said region of people group according to the optical flow magnitude of said designated pixels;

filtering said region of people group according to said density of optical flow magnitude.

In another embodiment, filtering said region of people group according to said density of optical flow magnitude comprises:

for each constructed region of people group, filtering out said region of people group if the density of optical flow magnitude of said region is greater than a preset third threshold value.

In another embodiment, before filtering said region of people group according to said density of optical flow magnitude, said method further comprises:

acquiring at least one positive sample region and at least one negative sample region of people group in the manually marked sample data;

computing the density of optical flow magnitude of said positive sample region and the density of optical flow magnitude of said negative sample region;

computing the third distribution graph of the density of optical flow magnitude of said positive sample region and the fourth distribution graph of the density of optical flow magnitude of said negative sample region;

acquiring the density of optical flow magnitude value corresponding to the intersection point of said third distribution graph and said fourth distribution graph;

defining said acquired density of optical flow magnitude value as said third threshold value.

Another objective of the embodiments of the present invention is to provide a device for people group detection, comprising:

an acquisition module for acquiring at least one corner and foreground region in video data;

a clustering module for computing according to said corner and foreground region acquired by said acquisition module to obtain at least one cluster;

a construction module for constructing at least one region of people group according to said cluster obtained by said clustering module.

In one embodiment, said clustering module comprises:

a processing unit for acquiring the intersection of the pixels in said corner and said foreground region to obtain a corner set;

a clustering unit for performing clustering operation on said corner set obtained by said processing unit by using clustering algorithm to obtain at least one cluster.

In another embodiment, said construction module is specifically used for constructing a region of people group for each obtained cluster by taking the cluster center as the center, and said region is a region containing the corners in said cluster.

In another embodiment, the region of people group constructed by said construction module for each cluster is specifically the minimal region containing all the corners in said cluster, said corner is a pixel with local structural characteristics in an image.

In another embodiment, said device further comprises:

a size filtering module for computing the size of at least one region of people group, filtering said region of people group according to the size of said region of people group after said region of people group constructed by said construction module; or

a corner density filtering module for computing the corner density of at least one region of people group, filtering said region of people group according to said corner density after said region of people group constructed by said construction module.

In another embodiment, said size filtering module is specifically used for computing the size of at least one region of people group, for each constructed region of people group, filtering out said region if the size of said region is smaller than a preset first threshold value after said region of people group constructed by said construction module.

In another embodiment, said corner density filtering module is specifically used for computing the corner densities of at least one region of people group, for each constructed region of people group, filtering out said region if the corner density of said region is smaller than a preset second threshold value after said region of people group constructed by said construction module.

In another embodiment, said device further comprises:

a first generation module for acquiring at least one positive sample region of people group and at least one negative sample region of people group in manually marked sample data; computing the corner density of said positive sample region and the corner density of said negative sample region; computing a first distribution graph of the corner density of said positive sample region and a second distribution graph of the corner density of said negative sample region; acquiring the corner density value corresponding to the intersection point of said first distribution graph and said second distribution graph; defining said acquired corner density value as said second threshold value.

In another embodiment, said device further comprises:

a density of optical flow magnitude filtering module for computing the optical flow magnitude of the designated pixels in at least one region of people group; computing the density of optical flow magnitude of said region of people group according to the optical flow magnitude of said designated pixels; filtering said region of people group according to said density of optical flow magnitude after said region of people group constructed by said construction module.

In another embodiment, said density of optical flow magnitude filtering module comprises:

a filtering unit for filtering out said region of people group if the density of optical flow magnitude of said region is greater than a preset third threshold value for each constructed region of people group when filtering said region of people group according to said density of optical flow magnitude.

In another embodiment, said device further comprises:

a second generation module for acquiring at least one positive sample region and at least one negative sample region of people group in the manually marked sample data; computing the density of optical flow magnitude of said positive sample region and the density of optical flow magnitude of said negative sample region; computing a third distribution graph of the density of optical flow magnitude of said positive sample region and a fourth distribution graph of the density of optical flow magnitude of said negative sample region; acquiring the density of optical flow magnitude value corresponding to the intersection point of said third distribution graph and said fourth distribution graph; defining said acquired density of optical flow magnitude value as said third threshold value.

The technical solutions provided in the embodiments of the present invention have the following advantages: according to the methods in the present embodiments, by acquiring at least one corner and foreground region in video data, computing, according to said corner and foreground region, to obtain at least one cluster, and constructing at least one region of people group according to said cluster, the automatic people group detection is realized, and the problem of the limited application in the prior art is solved; furthermore, the embodiment of the present invention is independent of the location detection of people, and it is not affected by the size of human image. The embodiments of the present invention can be applied to any scene including complicated ones, thus a wide application is increasingly gained, and the user demands can be better satisfied. Furthermore, the false detection regions in the constructed regions of people group can be filtered out by computing the sizes and/or corner densities of the regions of people group and performing filtering, which further improves the accuracy and robustness of people group detection.

### BRIEF DESCRIPTION OF THE SEVERAL VIEWS OF THE DRAWINGS

The present invention will become more fully understood from the accompanying drawings as below. However, these drawings are only exemplary. Still further variations can be readily obtained by one skilled in the art without burdensome and/or undue experimentation. Such variations are not to be regarded as a departure from the spirit and scope of the invention.

FIG. 1 shows a flowchart of a method for people group detection provided by the embodiments of the present invention.

FIG. 2 shows a flowchart of another method for people group detection provided by the embodiments of the present invention.

FIG. 3 shows a flowchart of another method for people group detection provided by the embodiments of the present invention.

FIG. 4 shows a distribution graph of the corner density provided in the embodiment of the present invention.

FIG. 5 shows a comparison diagram before and after filtration based on the sizes and corner densities of the regions provided by the embodiments of the present invention.

FIG. 6 shows a flowchart of another method for people group detection provided by the embodiments of the present invention.

FIG. 7 shows a distribution graph of the density of optical flow magnitude provided in the embodiment of the present invention.

FIG. 8 shows a comparison diagram before and after filtration based on the density of optical flow magnitude provided by the embodiments of the present invention.

FIG. 9 shows a structural diagram of a device for people group detection provided by the embodiments of the present invention.

FIG. 10 shows a structural diagram of another device for people group detection provided by the embodiments of the present invention.

### DETAILED DESCRIPTION OF THE INVENTION

To clarify the objectives, technical solutions, and advantages of the present invention, the embodiments of the present invention are further described in detail with reference to the attached drawings.

Referring to FIG. 1, a method for people group detection is provided according to an embodiment of the present invention, comprising:

101: Acquiring at least one corner and foreground region in video data.

102: Computing according to said corner and foreground region to obtain at least one cluster.

103: Constructing at least one region of people group according to said cluster.

According to the method in the present embodiment, by acquiring at least one corner and foreground region in video data, computing according to said corner and foreground region to obtain at least one cluster, and constructing at least one region of people group according to said cluster, the automatic people group detection is realized, and the problem of the limited application in the prior art is solved. Furthermore, the embodiment of the present invention is independent of the location detection of people and it is not affected by the size of human image; the embodiment of the present invention can be applied to any scene including complicated ones, thus a wide application is increasingly gained, and the user demands can be better satisfied.

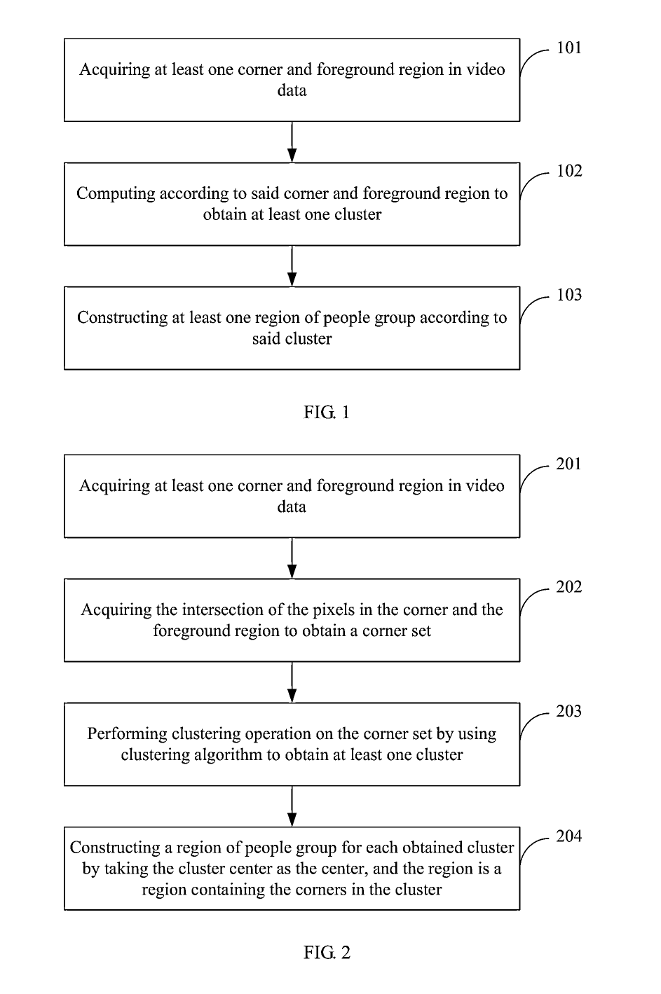

The embodiments of the present invention relate to people group detection, wherein, said people group includes a plurality of persons, at least two or more persons. Persons contained in the people group usually do not belong to the background of the scene and are in a static or invisible motion state. Therefore, in the embodiments of the present invention, people group is detected based on the foreground region. Referring to FIG. 2, a method for people group detection is provided in an embodiment of the present invention, which comprises:

201: Acquiring at least one corner and foreground region in video data.

A corner in the embodiments of the present invention is also called an interest point or a key point, which is a pixel with local structural characteristics in an image, such as the edge point and the intersection point of two lines, etc. The corner has the property of remaining unchanged in consistency when the image is transformed. Said transformation is referred to as scale changes, rotations, translations, zooming and illumination variations of the image. For example, motionless vehicles, pedestrians on roads and lawns in video data contain corners, and if there is a people group, obvious corners also exist. Therefore, features of the region of people group can be depicted with corner information. “Corner”, “interest point” and “key point” are replaceable for each other in the literature, thus are not distinguished in the present invention, and are uniformly called “corner” to facilitate better description. Corner is an image feature commonly used in the image processing field and can be extracted based on many types of information including but not limited to the type of edge, corner, or blob, etc.

Usually, content of an actual scene varies with time, and the foreground in the embodiments of the present invention is referred to as a dynamic object in an actual scene, such as people walking in a room, and vehicles moving on the road. Correspondingly, the background is referred to as static content, sometimes it is blocked by the foreground objects. Usually, a people group is formed by people coming from different directions and staying at a specific position. Thus, the region of people group usually belongs to the foreground object in the scene, and the foreground can be used to represent people group.

Said video data is referred to as video images collected by camera equipment. The camera equipment certainly can collect sounds, but this is not relative to the present invention, thus the video data in the present invention consists mainly of video images. Usually, the video images are collected in real time, which means that the corner acquisition and the foreground region extraction in the embodiments of the present invention are both executed in real time.

There are many methods for corner detection. For example, FAST algorithm can be used on video data for corner detection, or other corner detection algorithms, for example, including but not limited to Harris operator (Harris corner extraction method), SUSAN corner detector (SUSAN corner detection method), LoG (Laplacian of Gaussian) feature detection algorithm, etc., can also be used for corner detection. Generally, the result of the corner detection can be represented by a corner set:

CornerSet={p₁(x,y),p₂(x,y) . . . ,pₙ(x,y)} (1)

In this expression, n represents the number of corners, p represents a corner, (x,y) are coordinates of the corner p in the video image, x represents the horizontal coordinate, and y represents the vertical coordinate.

There also are many methods for foreground region extraction, such as the motion detection algorithm, etc. The specific algorithms for foreground region extraction are not limited in the present invention. Generally, the result of extracting the foreground region of the input image can be represented by the following:

$$Foreground ( x , y ) = \{ \begin{matrix}255 , & q ( x , y ) Belonging to the foreground pixel \\ 0 , & q ( x , y ) Not belonging to the foreground pixel\end{matrix} ; \qquad ( 2 )$$

wherein, q(x,y) represents the pixel in the input image, q(x,y) belongs to a foreground pixel of the input image when its gray value is 255, and q(x,y) does not belong to the foreground pixel of the input image when its gray value is 0. Specifically, it can be seen from the input image after the foreground is extracted that the black part is the background and the white protruding part is the foreground.

In the present embodiment, the sequence of acquiring the corners and the foreground regions is not fixed, which means the operations can be carried out successively or at the same time. There is no limitation in this aspect in the present invention.

202: Acquiring the intersection of the pixels in the corner and the foreground region to obtain a corner set.

Wherein, the result of acquiring the intersection is the pixels belonging to both the corners and the foreground regions, therefore a corner set is obtained.

Specifically, this step comprises the following: constructing a new corner set S, S=Ø at initial time;

determining if each corner p(x, y)εCornerSet acquired in step 201 belongs to the pixels in the foreground region, and if so, S=S∀p(x, y);

obtaining a new corner set S after traversing all the acquired corners, the corners in the new corner set belong to the foreground regions.

203: Performing clustering operation on the corner set by using clustering algorithm to obtain at least one cluster.

The clustering algorithm is an algorithm term in mathematics, which can summarize the characteristics of each category on the basis of similarity or focus on a certain specific category for further analysis. The so called “category” is usually referred to as a set of similar elements. Cluster analysis is also called group analysis, which is a statistic analysis method for studying classification. There are many clustering algorithms, including but not limited to K-mean value, Mean-shift, etc. Any one of the clustering algorithms may be adopted in the embodiments of the present invention, which is not limited in this aspect.

In this step, there are one or more clusters obtained by the clustering algorithm. For example, in one video scene, only one cluster is obtained, which is a walking person; in another video scene, two clusters are obtained, wherein one cluster is a people group including ten persons, and the other are two persons riding bicycles.

204: Constructing a region of people group for each obtained cluster by taking the cluster center as the center, and the region is a region containing the corners in the cluster.

In another embodiment of the present invention, preferably, this step may specifically comprise:

constructing a region of people group for each obtained cluster by taking the cluster center as the center, and the region is the minimal region containing all the corners in the cluster, said corner is a pixel with local structural characteristics in the image. For example, a round region of people group is constructed for each obtained cluster by taking the cluster center as the circle center, and the radius of the region is the minimal radius of the circle containing all the corners in the cluster.

In the present embodiment, the round region of people group is constructed as an example. Of course, in other embodiments, other shapes of regions of people groups can be constructed, such as square, rectangle, oval, etc., which is not limited in this aspect in the present invention.

When constructing a region of people group according to the cluster, the region of people group in any size can be constructed as long as the region contains all the corners in this cluster, such as round regions with different radiuses. Preferably, the smallest circle containing all the corners in the cluster is selected in the present embodiment to construct the region of people group to represent the region of people group more precisely.

In the present embodiment, furthermore, the constructed regions of people group can be assigned with a corresponding ID to facilitate the storage thereof. Wherein, there are many methods for assigning the ID, for example, the ID can be assigned according to the sequence of construction time. For example, three regions of people group are constructed in the interval from time t1 to time t2 and then assigned with ID1, ID2 and ID3 in turn. Of course, other methods for assigning the ID can also be used in another embodiment of the present invention. For example, in the cases that the identical people group shows up at different times or in different locations, the people group can be marked by using a method of matching the similarity of the image information and assigned with the same ID. There is no limitation in this aspect in the present invention. Moreover, the information such as the assigned ID value and the assignment time can be associated and recorded together to facilitate the subsequent analysis and computation. There is no limitation in this aspect in the present invention.

According to the method provided in the present embodiment, by acquiring at least one corner and foreground region in video data, computing, according to said corner and foreground region, to obtain at least one cluster, and constructing at least one region of people group according to said cluster, the automatic people group detection is realized and the problem of the limited application in the prior art is solved; furthermore, the embodiment of the present invention is independent of the location detection of people and it is not affected by the size of human image. The embodiment of the present invention can be applied to any scene including complicated ones, thus a wide application is increasingly gained, and the user demands can be better satisfied. Wherein, being constructed in a round shape, the region of people group is more perceivable and can be accessed easily. By being constructed based on the smallest circle containing all the corners in the cluster, the region of people group can be represented more precisely.

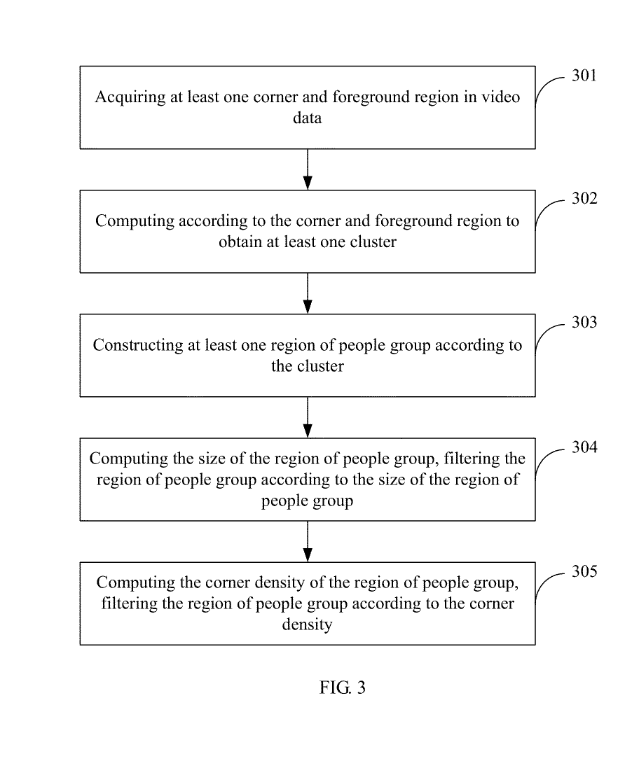

After the regions of people group are constructed according to the above mentioned embodiment, there may be some false detection, therefore the constructed regions of people group shall be filtered. Referring to FIG. 3, a method for people group detection is further provided in the embodiment of the present invention, wherein a filtering operation is carried out according to the size or corner density of the region after the regions of people group are constructed to improve the accuracy of the detection. The method comprises:

301: Acquiring at least one corner and foreground region in video data.

302: Computing, according to the corner and foreground region, to obtain at least one cluster.

303: Constructing at least one region of people group according to the cluster.

The detailed realization processes of steps 301 to 303 are identical with the description in the above mentioned embodiment and will not be described in the present embodiment.

The following are steps to filter the constructed regions of people group, including step 304 and/or step 305.

304: Computing the size of the region of people group, filtering the region of people group according to the size of the region of people group.

Specifically, for each constructed region of people group, if the computed size of the region is smaller than a preset first threshold value, then this region shall be filtered out. Wherein said preset first threshold value is a boundary value preset according to the shape of the region of people group and usually is a relatively small value, therefore, when the size of the constructed region of people group is smaller than this threshold value, it means that this region of people group is relatively small and may be a false detection, for example, it may be a person in a static vehicle or on a lawn, etc. By filtering based on the size of the region of people group, the smaller regions can be filtered out and the regions of which the sizes are larger than the first threshold value are retained, thus the false detected regions are filtered out, and the detection accuracy is further improved.

Preferably, when regions of people group are constructed in round, said first preset threshold value is a preset threshold value of radius. During filtering operations, the radius of each round region of people group shall be computed and compared with the threshold value of radius; if the radius is smaller than the threshold value of radius, the region shall be filtered out; and if the radius is larger than the threshold value of radius, the region shall be retained.

305: Computing the corner density of the region of people group, filtering the region of people group according to the corner density.

There are many ways to compute said corner density of the region of people group. There is no limitation in this aspect in the present invention. For example, the following formula can be adopted to compute the corner density:

CornerDensity=Number of Corners/πr² (3)

Wherein said number of the corners is referred to as the total number of all the corners in the region of people group; r represents the radius of the region of people group; and πr² represents the area of the region of people group.

In practical applications, any one of the two steps of filtering the regions of people group according to the size in 304 and filtering the regions of people group according to the corner density in 305 can be selected for execution. Preferably, both steps can be executed to further improve the detection accuracy. When both steps are executed, there is no limitation on the sequence of the steps. No matter which step is executed first, filtering is performed on the basis of the result of the previous filtration in the latter step, which will not be described in detail here. For example, in the case when 305 is executed after 303, the regions of people group in 305 are referred to as the regions of people group constructed in step 303; in the case when 305 is executed after 304, said regions of people group are referred to as those retained after the filtration in 304.

In this step, filtering the regions of people group according to the corner density specifically may comprise the following step:

for each constructed region of people group, filtering out said region if the corner density of said region is smaller than a preset second threshold value.

Wherein, said preset second threshold value is a preset boundary value of the corner density; when the corner density of a region of people group is smaller than the second threshold value, it means that the corner density of this region is relatively low and may be a false detection, therefore it shall be filtered out. When the corner density of a region of people group is greater than the second threshold value, it means that the corner density of this region is relatively high and proper, and then this region is regarded as the correct region of people group and therefore shall be retained. By filtering based on the corner density of the region of people group, the regions with small corner densities can be filtered out and the regions of which the corner densities are greater than the second threshold value are retained, thus the false detected regions are filtered out, and the detection accuracy is further improved.

In the present embodiment, said second threshold value may be a fixed value set according to experience, such as 0.6, etc., there is no limitation in this aspect in the present invention. Of course, the method of automatically setting the second threshold value can be also adopted to ensure that the second threshold value is set more rationally and reflects the actual situation of the corner density more precisely. Specifically, in the above mentioned method, before filtering the region of people group according to the corner density, the above mentioned method also comprises:

acquiring at least one positive sample region of people group and at least one negative sample region of people group in manually marked sample data;

computing the corner density of the positive sample region and the corner density of the negative sample region;

computing the first distribution graph of the corner density of the positive sample region and the second distribution graph of the corner density of the negative sample region;

acquiring the corner density value corresponding to the intersection point of the first distribution graph and the second distribution graph;

defining the acquired corner density value as the second threshold value.

Wherein said sample data is the video data collected in advance, preferably, the video data is collected from the scene related to the scene of the video data to be detected, or the video data is collected from the same scene of the video data to be detected. Said positive sample region is referred to as the region that is manually marked as a positive example, namely the region of people group; and said negative sample region is referred to as the region that is manually marked as a negative example, namely the region without people group. The number of acquired regions of positive samples may be one or more. When there is more than one positive sample region, those positive sample regions constitute a positive sample set, and in such circumstances, the first distribution graph can be obtained by computing based on the corner density values of all positive sample regions in the positive sample set. The number of acquired regions of negative samples may be one or more. When there is more than one negative sample region, those negative sample regions constitute a negative sample set, and in such circumstances the second distribution graph can be obtained by computing based on the corner density values of the negative sample regions in the negative sample set.

The distribution graph of said corner densities reflects the distribution of the corner densities. Wherein, the horizontal coordinate of the distribution graph represents the corner density value, while the vertical coordinate represents the ratio of the sample region corresponding to each corner density value to all the sample regions. For example, there are 100 positive sample regions, among, which 20 regions have the corner density values of T, then the distribution corresponding to the corner density value T is 20%.

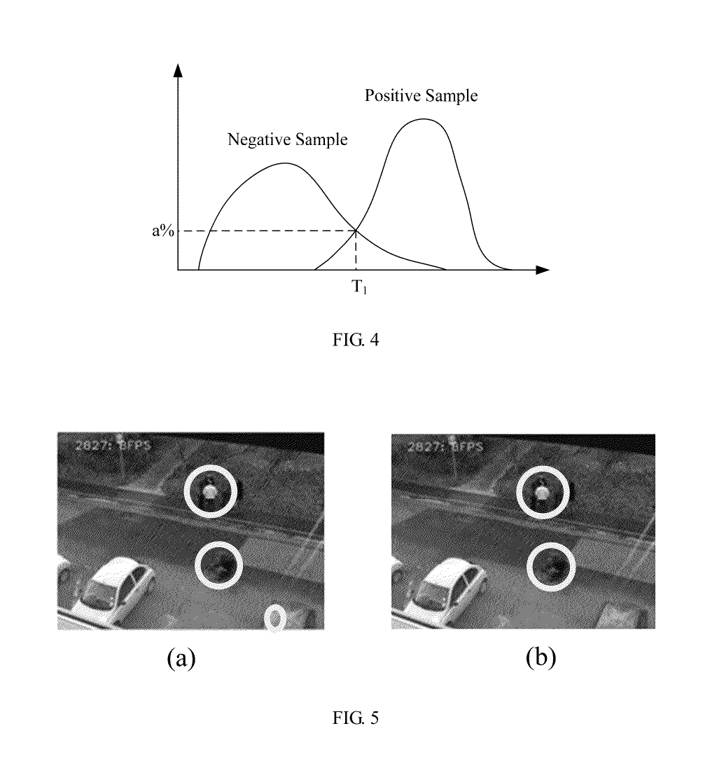

FIG. 4 illustrates the schematic diagram of the corner density distribution used to automatically set the second threshold value, wherein two curves represent the distribution graph of the corner densities of the positive sample region and the distribution graph of the corner densities of the negative sample regions, respectively. The corner density value corresponding to the intersection point of the two curves is T₁, and the ratio corresponding to the corner density value T₁ is a %, which means that the sample regions with the corner density value T₁ in the positive and negative sample regions account for a % of the total number of sample regions. The corner density value T₁ is used as said second threshold value to filter the regions of people group according to said corner density, and thus the detection accuracy can be further improved.

According to the method provided in the present embodiment, by acquiring at least one corner and foreground region in video data, computing, according to said corner and foreground region, to obtain at least one cluster, and constructing at least one region of people group according to said cluster, the automatic people group detection is realized and the problem of the limited application in the prior art is solved. Furthermore, the embodiment of the present invention is independent of the location detection of people, and it is not affected by the size of human image. The embodiment of the present invention can be applied to any scene including complicated ones, thus a wide application is increasingly gained, and the user demands can be better satisfied.

Furthermore, the false detection regions in the constructed regions of people group can be filtered out by computing the sizes and/or corner densities of the regions of people group and performing filtering, which further improves the accuracy and robustness of people group detection. FIG. 5 illustrates the schematic diagram of filtering the constructed regions of people group. Wherein, FIG. 5(a) shows three regions of people group constructed by the method provided in the present embodiment; the regions of people group showed in FIG. 5(b) are obtained after being filtered according to the size and corner density of the region of people group. It shows that one false detection region can be filtered out, therefore the accuracy of the people group detection is improved.

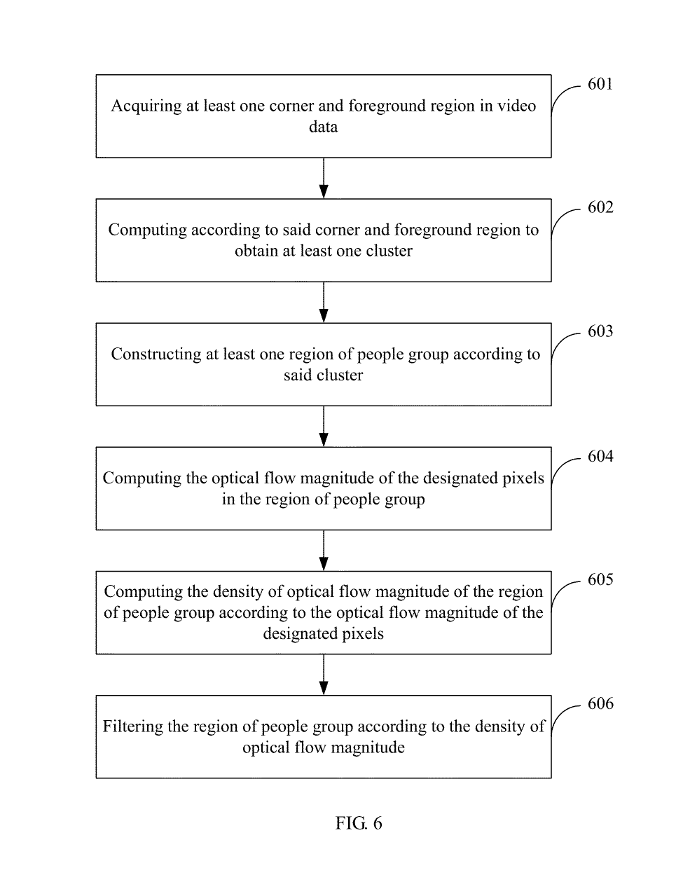

Usually there may be many corners on the image of moving pedestrians or objects which do not belong to people group, thus false detection may occur. Therefore, referring to FIG. 6, a method for people group detection is provided according to the embodiment of the present invention. It is different from the above mentioned method in that the constructed region of people group is filtered according to the density of optical flow magnitude, such that the false detection on moving pedestrians or objects is filtered out to improve the detection accuracy. The method comprises:

601: Acquiring at least one corner and foreground region in video data.

602: Computing, according to said corner and foreground region, to obtain at least one cluster.

603: Constructing at least one region of people group according to said cluster.

The detailed realization processes of steps 601 to 603 are identical with the description in the above mentioned embodiment and will not be described in the current embodiment.

604: Computing the optical flow magnitude of the designated pixels in the region of people group.

The optical flow or optic flow in the embodiments of the present invention is a concept related to object motion detection in video. It is referred to as the instant speed of the pixel motion of a moving object in an observed image surface. It can reflect the motion state of the object. The study of the optical flow is to determine the motion of each pixel location by utilizing the change in time domain and the relativity of the pixel value data in an image sequence. Usually, the optical flow information of an object in an invisible moving state is relatively weak, while the optical flow information of the object in an obvious moving state is relatively strong. When people are grouped, they stay at a specific location and are not in an obvious moving state, the optical flow information is relatively weak. Therefore, the region of people group and the object region moving obviously can be distinguished in the video data by the optical flow information. Optical flow information includes optical flow direction and optical flow magnitude. The optical flow magnitude is mostly related in the present invention, while the optical direction is not described in detail.

There are many methods to compute the optical flow magnitude. In the present invention, any method such as Lucas-Kanade (LK) method, Horn-Schunk (HS) method, the combination method of LK and HS, can be adopted to compute to the optical flow magnitude. There is no limitation in this aspect in the present embodiment.

Wherein, said designated pixels are predetermined pixels in said region of people group, specifically part of the pixels in the region, or all the pixels in the region. There is no limitation in this aspect in the present embodiment. Preferably, all the pixels in the region can be designated to compute the optical flow magnitude of all the pixels in the region.

605: Computing the density of optical flow magnitude of the region of people group according to the optical flow magnitude of the designated pixels.

Specifically, the density of optical flow magnitude of a region of people group can be computed by the following formula:

$$Density of optical flow magnitude = \frac{{\sum }_{Area} Optical flow magnitude of designated pixel}{π {r}^{2}} \qquad ( 4 )$$

wherein, the numerator is the sum of the optical flow magnitude of the designated pixels in the region of people group Area; r is the radius of the region of people group Area; and πr² represents the area of the region of people group.

606: Filtering the region of people group according to the density of optical flow magnitude.

Wherein, filtering the region of people group according to the density of optical flow magnitude specifically comprises:

for each constructed region of people group, filtering out the region of people group if the density of optical flow magnitude of the region is greater than a preset third threshold value.

Wherein, said preset third threshold value is a preset boundary value of the density of optical flow magnitude; when the density of optical flow magnitude of a region of people group is greater than the third threshold value, it means that the density of optical flow magnitude of this region is relatively high, and this region may be a false detection, such as pedestrians or objects moving obviously. Therefore this region shall be filtered out. When the density of optical flow magnitude of a region of people group is smaller than the third threshold value, it means that the density of optical flow magnitude of this region is relatively low, such as the people in a static state, and this region is regarded as the correct region of people group and therefore shall be retained. By filtering based on the density of optical flow magnitude of the region of people group, the regions with large densities of optical flow magnitude can be filtered out and the regions of which the densities of optical flow magnitude are smaller than the third threshold value are retained, thus the false detected regions involved in a moving state are filtered out, and the detection accuracy is further improved.

In the present embodiment, said third threshold value may be a fixed value set according to experience, such as 0.6, etc., there is no limitation in this aspect in the present invention. Of course, the method of automatically setting the third threshold value can also be adopted to ensure that the third threshold value is set more rationally and reflects the actual situation of the density of optical flow magnitude more precisely. Specifically, in the above mentioned method, before filtering the region of people group according to the density of optical flow magnitude, the above mentioned method also comprises:

acquiring at least one positive sample region and at least one negative sample region of people group in the manually marked sample data;

computing the density of optical flow magnitude of the positive sample region and the density of optical flow magnitude of the negative sample region;

computing a third distribution graph of the density of optical flow magnitude of the positive sample region and a fourth distribution graph of the density of optical flow magnitude of the negative sample region;

acquiring a density value of optical flow magnitude corresponding to the intersection point of the third distribution graph and the fourth distribution graph;

defining the acquired density value of optical flow magnitude as a third threshold value.

Wherein, said sample data is the video data which is collected in advance, preferably is the video data collected from the scene related to the scene of the video data to be detected, or the video data collected from the same scene of the video data to be detected. Said positive sample region is referred to as the region that is manually marked as a positive example, namely the region of people group; and said negative sample region is referred to as the region that is manually marked as a negative example, namely the region without people group. The number of acquired regions of positive sample may be one or more. When there is more than one positive sample region, those positive sample regions constitute a positive sample set, and in such circumstances the third distribution graph can be obtained by computing optical flow magnitude based on the density values of all positive sample regions in the positive sample set. The number of acquired regions of negative sampled may be one or more. When there is more than one negative sample region, those negative sample regions constitute a negative sample set, and in such circumstances the fourth distribution graph can be obtained by computing optical flow magnitude based on the density values of the negative sample regions in the negative sample set.

The distribution graph of said densities of optical flow magnitude reflects the distribution of the densities of optical flow magnitude. Wherein, the horizontal coordinate of the distribution graph represents the density value of optical flow magnitude, while the vertical coordinate represents the ratio of the sample regions corresponding to each density value of optical flow magnitude to all the sample regions. For example, there are 100 positive sample regions, among which 15 regions have the density values of optical flow magnitude of T, and then the distribution corresponding to the density value of optical flow magnitude T is 15%.

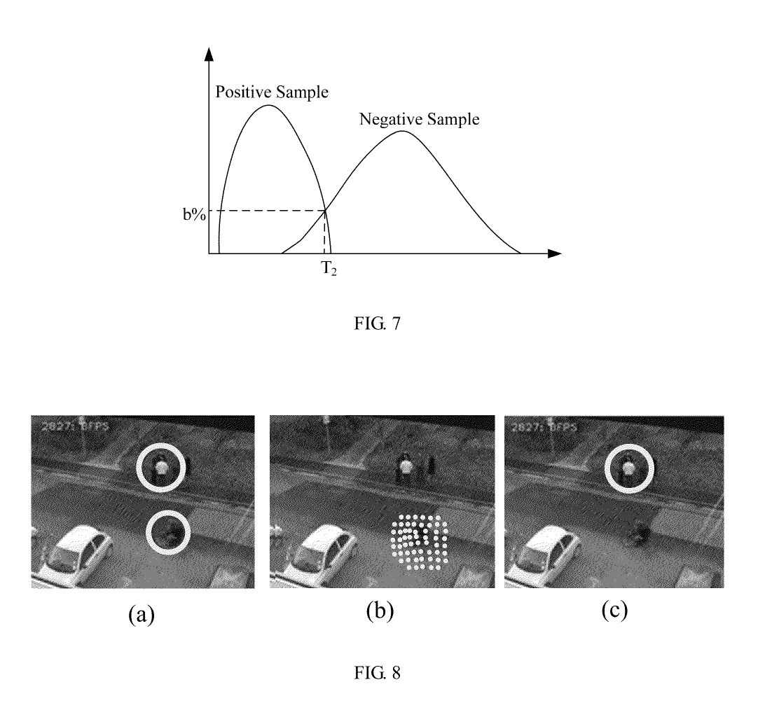

FIG. 7 illustrates the schematic diagram of the density of optical flow magnitude distribution used to automatically set the third threshold value, wherein two curves represent the distribution graph of the densities of optical flow magnitude of the positive sample region and the distribution graph of the densities of optical flow magnitude of the negative sample regions, respectively. The density value of optical flow magnitude corresponding to the intersection point of the two curves is T₂; and the ratio corresponding to the density value of optical flow magnitude T₂ is b %, which means that the sample regions with the density value of optical flow magnitude T₂ in the positive and negative sample regions account for b % of the total number of sample regions. The density value of optical flow magnitude T₂ is used as said third threshold value to filter the regions of people group according to said density of optical flow magnitude, and thus the detection accuracy can be further improved.

In practical application, the step of filtering the region of people group according to the density of optical flow magnitude in the present embodiment can be used in combination with the steps of filtering the region of people group according to the size and/or corner density thereof in the above mentioned embodiment, which means that the region of people group can be filtered according to at least one of the following: the size of a selected region, corner density and density of optical flow magnitude. Preferably, those three ways can be adopted respectively to further improve the detection accuracy. When the above mentioned two or three ways are adopted, the filtering steps of each ways are independent and have no impact on each other, and there is no fixed sequence in the filtering steps. There is no limitation in this aspect in the present invention.

According to the method in the present embodiment, by acquiring at least one corner and foreground region in video data, computing, according to said corner and foreground region, to obtain at least one cluster, and constructing at least one region of people group according to said cluster, the automatic people group detection is realized and the problem of the limited application in the prior art is solved. Furthermore, the embodiment of the present invention is independent of the location detection of people, and it is not affected by the size of human image. The embodiment of the present invention can be applied to any scene including complicated ones, thus a wide application is increasingly gained, and the user demands can be better satisfied.

Furthermore, the false detection regions such as regions related to motion state in the constructed regions of people group can be filtered out by computing the densities of optical flow magnitude of the regions of people group and performing filtering, which further improves the accuracy and robustness of people group detection. For example, FIG. 8 illustrates the schematic diagram of filtering the constructed regions of people group. Wherein FIG. 8(a) shows two regions of people group constructed by the method provided in the embodiment of the present invention; FIG. 8(b) illustrates a false detection region obtained by computing the density of optical flow magnitude of the region of people group and of which the density of optical flow magnitude is greater than the third threshold value; and FIG. 8(c) shows the regions of people group after the false detection region is filtered out. It shows that the accuracy of the people group detection is further improved after filtering based on the density of optical flow magnitude.

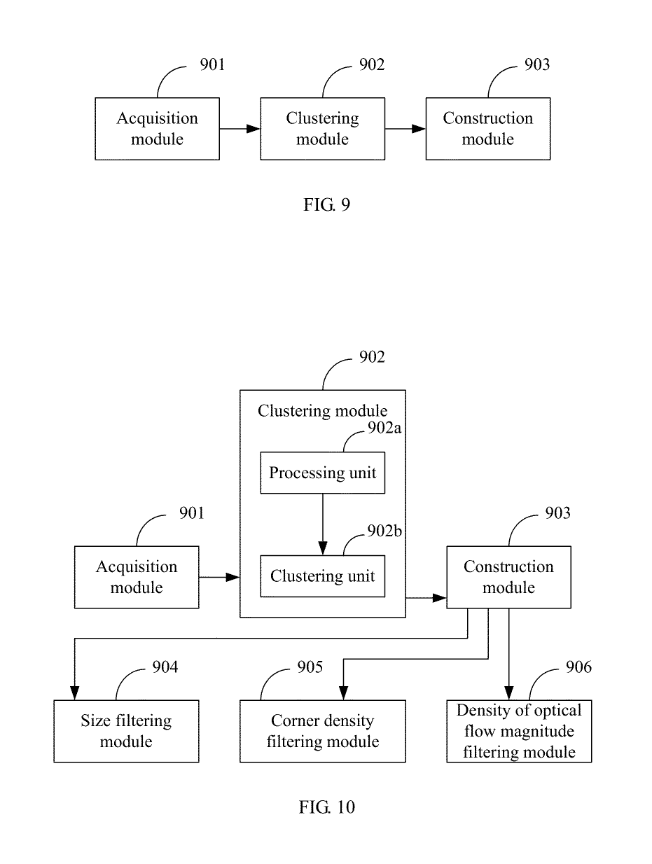

Referring to FIG. 9, in the embodiments of the present invention, a device for people group detection is provided, comprising:

an acquisition module 901 for acquiring at least one corner and foreground region in video data;

a clustering module 902 for computing according to said corner and foreground region acquired by said acquisition module to obtain at least one cluster;

a construction module 903 for constructing at least one region of people group according to said cluster obtained by said clustering module.

In the present embodiment, the sequence of acquiring the corners and the foreground regions by the acquisition module 901 is not fixed, which means the operations can be carried out successively or at the same time. There is no limitation in this aspect in the present invention.

Said video data is referred to as video images collected by camera equipment. The camera equipment certainly can collect sounds, but this is not relative to the present invention, thus the video data in the present invention consists mainly of video images. Usually, the video images are collected in real time, which means that the corner acquisition and the foreground region extraction in the embodiments of the present invention are both executed in real time.

Referring to FIG. 10, in one embodiment, said clustering module 902 may comprise:

a processing unit 902a for acquiring the intersection of the pixels in said corner and said foreground region to obtain a corner set;

a clustering unit 902b for performing clustering operations on said corner set obtained by said processing unit 902a by using a clustering algorithm to obtain at least one cluster.

In another embodiment, said construction module 903 is specifically used for constructing a region of people group for each obtained cluster by taking the cluster center as the center, and the region is a region containing the corners in the cluster. In another embodiment of the present invention, preferably, said construction module 903 may be specifically used for constructing a region of people group for each obtained cluster by taking the cluster center as the center, and the region is the minimal region containing all the corners in the cluster, said corner is a pixel with local structural characteristics in the image.

When constructing a region of people group according to the cluster, the region of people group in any size can be constructed as long as the region contains all the corners in this cluster, such as round regions with different radiuses. Preferably, the construction module 903 is specifically used for constructing a round region of people group for each obtained cluster by taking the cluster center as the circle center, and the radius of the region is the minimal radius of the circle containing all the corners in the cluster, thus the region of people group can be represented more precisely.

In the present embodiment, the round region of people group is constructed as an example. Of course, in other embodiments, other shapes of regions of people group can be constructed, such as square, rectangle, oval, etc., which is not limited in this aspect in the present invention.

Furthermore, said device provided in the embodiments of the present invention further comprises:

a size filtering module 904 for computing the size of at least one region of people group, filtering the region of people group according to the size of the region of people group after the region of people group constructed by the construction module; or

a corner density filtering module 905 for computing the corner density of at least one region of people group, filtering the region of people group according to the corner density after the region of people group constructed by the construction module.

In practical application, either the means of filtering the regions of people group according to the size by the size filtering module 904 or the means of filtering the regions of people group according to the corner density by the corner density filtering module 905 can be selected for execution. Preferably, both means can be executed to further improve the detection accuracy. When both steps are executed, there is no limitation on the sequence of the steps.

The size filtering module 904 is specifically used for computing the size of at least one region of people group, for each constructed region of people group, filtering out the region if the size of the region is smaller than a preset first threshold value after the region of people group constructed by the construction module.

The corner density filtering module 905 is specifically used for computing the corner densities of at least one region of people group, for each constructed region of people group, filtering out the region if the corner density of the region is smaller than a preset second threshold value after the region of people group constructed by the construction module.

Wherein, said preset second threshold value is a preset boundary value of the corner density; when the corner density of a region of people group is smaller than the second threshold value, it means that the corner density of this region is relatively low and may be a false detection, therefore it shall be filtered out. By filtering based on the corner density of the region of people group, the false detected regions with small corner densities can be filtered out, thus the detection accuracy is further improved.

In the present embodiment, said second threshold value may be a fixed value set according to experience, such as 0.6, etc., there is no limitation in this aspect in the present invention. Of course, the method of automatically setting the second threshold value can be also adopted to ensure that the second threshold value is set more rationally and reflects the actual situation of the corner density more precisely. Specifically, said device further comprises:

a first generation module for acquiring at least one positive sample region of people group and at least one negative sample region of people group in the manually marked sample data; computing the corner density of the positive sample region and the corner density of the negative sample region; computing the first distribution graph of the corner density of the positive sample region and the second distribution graph of the corner density of the negative sample region; acquiring the corner density value corresponding to the intersection point of the first distribution graph and the second distribution graph; defining the acquired corner density value as the second threshold value.

Wherein said sample data acquired by said first generation module is the video data collected in advance, preferably is the video data collected from the scene related to the scene of the video data to be detected, or the video data collected from the same scene of the video data to be detected. Said positive sample region is referred to as the region that is manually marked as a positive example, namely the region of people group; and said negative sample region is referred to as the region that is manually marked as a negative example, namely the region without people group. The number of acquired regions of positive sample may be one or more. When there is more than one positive sample region, those positive sample regions constitute a positive sample set, and in such circumstances the first distribution graph can be obtained by computing based on the corner density values of all positive sample regions in the positive sample set. The number of acquired regions of negative sample may be one or more. When there is more than one negative sample region, those negative sample regions constitute a negative sample set, and in such circumstances the second distribution graph can be obtained by computing based on the corner density values of the negative sample regions in the negative sample set.

In this embodiment, in another means, said device may further comprise:

a density of optical flow magnitude filtering module 906 for computing the optical flow magnitude of the designated pixels in at least one region of people group; computing the density of optical flow magnitude of the region of people group according to the optical flow magnitude of the designated pixels; filtering the region of people group according to the density of optical flow magnitude after the region of people group constructed by the construction module.

Said designated pixels are predetermined pixels in said region of people group, specifically part of the pixels in the region, or all the pixels in the region. There is no limitation in this aspect in the present embodiment.

The density of optical flow magnitude filtering module 906 may comprise:

a filtering unit for filtering out the region of people group if the density of optical flow magnitude of the region is greater than a preset third threshold value for each constructed region of people group when filtering the region of people group according to the density of optical flow magnitude.

Wherein, said preset third threshold value is a preset boundary value of the density of optical flow magnitude; when the density of optical flow magnitude of a region of people group is greater than the third threshold value, it means that the density of optical flow magnitude of this region is relatively high, and this region may be a false detection, such as pedestrians or objects moving obviously, therefore this region shall be filtered out. By filtering based on the density of optical flow magnitude of the region of people group, the regions with large densities of optical flow magnitude can be filtered out and the regions of which the densities of optical flow magnitude are smaller than the third threshold value are retained, thus the false detected regions involved in a moving state are filtered out, and the detection accuracy is further improved.

In the present embodiment, said third threshold value may be a fixed value set according to experience, such as 0.6, etc., there is no limitation in this aspect in the present invention. Of course, the method of automatically setting the third threshold value can be also adopted to ensure that the third threshold value is set more rationally and reflects the actual situation of the density of optical flow magnitude more precisely. Specifically, said device may further comprise:

a second generation module for acquiring at least one positive sample region and at least one negative sample region of people group in the manually marked sample data; computing the density of optical flow magnitude of the positive sample region and the density of optical flow magnitude of the negative sample region; computing the third distribution graph of the density of optical flow magnitude of the positive sample region and the fourth distribution graph of the density of optical flow magnitude of the negative sample region; acquiring the density of optical flow magnitude value corresponding to the intersection point of the third distribution graph and the fourth distribution graph; defining the acquired density value of optical flow magnitude as the third threshold value.

Said sample data acquired by said second generation module is the video data which is collected in advance, preferably is the video data collected from the scene related to the scene of the video data to be detected, or the video data collected from the same scene of the video data to be detected. Said positive sample region is referred to as the region that is manually marked as a positive example, namely the region of people group; and said negative sample region is referred to as the region that is manually marked as a negative example, namely the region without people group. The number of acquired regions of positive sample may be one or more. When there is more than one positive sample region, those positive sample regions constitute a positive sample set, and in such circumstances the third distribution graph can be obtained by computing based on the density values of optical flow magnitude of all positive sample regions in the positive sample set. The number of acquired regions of negative sample may be one or more. When there is more than one negative sample region, those negative sample regions constitute a negative sample set, and in such circumstances the fourth distribution graph can be obtained by computing based on the density values of optical flow magnitude of the negative sample regions in the negative sample set.

The device provided in the present embodiment may execute any one of methods provided in the above mentioned embodiments. See the descriptions of the embodiments of method for specific process and details thereof are omitted. Said device may be located in equipment such as a computer, which is not limited here.

According to the device provided in the present embodiment, by acquiring at least one corner and foreground region in video data, computing according to said corner and foreground region to obtain at least one cluster, and constructing at least one region of people group according to said cluster, the automatic people group detection is realized and the problem of the limited application in the prior art is solved. Furthermore, the embodiment of the present invention is independent of the location detection of people and it is not affected by the size of human image. The embodiment of the present invention can be applied to any scene including complicated ones, thus a wide application is increasingly gained, and the user demands can be better satisfied.

Wherein, by being constructed in a round shape, the region of people group is more perceivable and can be accessed easily. By being constructed based on the smallest circle containing all the corners in the cluster, the region of people group can be represented more precisely. Furthermore, the false detection regions in the constructed regions of people group can be filtered out by computing the sizes and/or corner densities of the regions of people group and performing filtering, which further improves the accuracy and robustness of people group detection.

Those ordinarily skilled in this field can understand that all or part of the steps for realizing the above mentioned embodiments can be completed by hardware or by the related hardware under the direction of a program; said program can be stored in a readable memory media which may be a ROM, a disc or an optical disc.

The above mentioned descriptions are exemplary embodiments of the present invention, which cannot limit the present invention. Within the spirit and principle of the present invention, any modification, equivalent substitution or improvement all shall be included in the protection scope of the present invention.

What is claimed is:

1. A method for people group detection, comprising:
acquiring at least one corner and foreground region in video data;
computing, according to said corner and foreground region, to obtain at least one cluster; and
constructing at least one region of people group according to said cluster.

2. The method according to claim 1, wherein said computing according to said corner and foreground region to obtain at least one cluster comprises:
acquiring an intersection of pixels in said corner and said foreground region to obtain a corner set; and
performing a clustering operation on said corner set by using a clustering algorithm to obtain the at least one cluster.

3. The method according to claim 1, wherein constructing at least one region of people group according to said cluster comprises:
constructing a region of people group for each obtained cluster by taking a cluster center as a center, and said region is a region containing the corners in said cluster.

4. The method according to claim 3, wherein the region of people group constructed for each cluster is specifically a minimal region containing all the corners in said cluster, said corner is a pixel with local structural characteristics in an image.

5. The method according to claim 1, wherein after constructing at least one region of people group according to said cluster, said method further comprises:
computing a size of said region of people group, filtering said region of people group according to the size of said region of people group; or
computing the corner density of said region of people group, filtering said region of people group according to said corner density.

6. The method according to claim 5, wherein filtering said region of people group according to the size of said region of people group comprises:
for each constructed region of people group, filtering out said region if the size of said region is smaller than a preset first threshold value.

7. The method according to claim 5, wherein filtering said region of people group according to said corner density comprises:
for each constructed region of people group, filtering out said region if the corner density of said region is smaller than a preset second threshold value.

8. The method according to claim 7, wherein before filtering said region of people group according to said corner density, said method further comprises:
acquiring at least one positive sample region of people group and at least one negative sample region of people group in a manually marked sample data;
computing the corner density of said positive sample region and the corner density of said negative sample region;
computing a first distribution graph of the corner density of said positive sample region and a second distribution graph of the corner density of said negative sample region;
acquiring the corner density value corresponding to an intersection point of said first distribution graph and said second distribution graph; and
defining said acquired corner density value as said second threshold value.

9. The method according to claim 1, wherein after constructing at least one region of people group according to said cluster, said method further comprises:
computing an optical flow magnitude of the designated pixels in said region of people group;
computing a density of optical flow magnitude of said region of people group according to the optical flow magnitude of said designated pixels; and
filtering said region of people group according to said density of optical flow magnitude.

10. The method according to claim 9, wherein filtering said region of people group according to said density of optical flow magnitude comprises:
for each constructed region of people group, filtering out said region of people group if the density of optical flow magnitude of said region is greater than a preset third threshold value.

11. The method according to claim 10, wherein before filtering said region of people group according to said density of optical flow magnitude, said method further comprises:
acquiring at least one positive sample region and at least one negative sample region of people group in a manually marked sample data;
computing a density of optical flow magnitude of said positive sample region and a density of optical flow magnitude of said negative sample region;
computing a third distribution graph of the density of optical flow magnitude of said positive sample region and a fourth distribution graph of the density of optical flow magnitude of said negative sample region;
acquiring a density value of optical flow magnitude corresponding to an intersection point of said third distribution graph and said fourth distribution graph; and
defining said acquired density value of optical flow magnitude as said third threshold value.

12. A device for people group detection, comprising:
an acquisition module for acquiring at least one corner and foreground region in video data;
a clustering module for computing, according to said corner and foreground region acquired by said acquisition module, to obtain at least one cluster; and
a construction module for constructing at least one region of people group according to said cluster obtained by said clustering module.

13. The device according to claim 12, wherein said clustering module comprises:
a processing unit for acquiring an intersection of pixels in said corner and said foreground region to obtain a corner set;
a clustering unit for performing a clustering operation on said corner set obtained by said processing unit by using a clustering algorithm to obtain at least one cluster.

14. The device according to claim 12, wherein said construction module is specifically used for constructing a region of people group for each obtained cluster by taking a cluster center as a center, and said region is a region containing the corners in said cluster.

15. The device according to claim 14, wherein the region of people group constructed by said construction module for each cluster is specifically a minimal region containing all the corners in said cluster, said corner is a pixel with local structural characteristics in an image.

16. The device according to claim 12, wherein said device further comprises:
a size filtering module for computing a size of at least one region of people group, filtering said region of people group according to the size of said region of people group after said region of people group is constructed by said construction module; or
a corner density filtering module for computing the corner density of at least one region of people group, filtering said region of people group according to said corner density after said region of people group is constructed by said construction module.

17. The device according to claim 16, wherein said size filtering module is specifically used for computing a size of at least one region of people group, for each constructed region of people group, filtering out said region if the size of said region is smaller than a preset first threshold value after said region of people group is constructed by said construction module.

18. The device according to claim 16, wherein said corner density filtering module is specifically used for computing the corner densities of at least one region of people group, for each constructed region of people group, filtering out said region if the corner density of said region is smaller than a preset second threshold value after said region of people group is constructed by said construction module.

19. The device according to claim 18, wherein said device further comprises:
a first generation module for acquiring at least one positive sample region of people group and at least one negative sample region of people group in a manually marked sample data; computing the corner density of said positive sample region and the corner density of said negative sample region; computing a first distribution graph of the corner density of said positive sample region and a second distribution graph of the corner density of said negative sample region; acquiring the corner density value corresponding to an intersection point of said first distribution graph and said second distribution graph; and defining said acquired corner density value as said second threshold value.

20. The device according to claim 12, wherein said device further comprises:
a density of optical flow magnitude filtering module for computing an optical flow magnitude of designated pixels in at least one region of people group; computing a density of optical flow magnitude of said region of people group according to the optical flow magnitude of said designated pixels; filtering said region of people group according to said density of optical flow magnitude after said region of people group is constructed by said construction module.

21. The device according to claim 20, wherein said density of optical flow magnitude filtering module comprises:
a filtering unit for filtering out said region of people group if the density of optical flow magnitude of said region is greater than a preset third threshold value for each constructed region of people group when filtering said region of people group according to said density of optical flow magnitude.

22. The device according to claim 21, wherein said device further comprises:
a second generation module for acquiring at least one positive sample region and at least one negative sample region of people group in a manually marked sample data; computing a density of optical flow magnitude of said positive sample region and the density of optical flow magnitude of said negative sample region; computing a third distribution graph of the density of optical flow magnitude of said positive sample region and a fourth distribution graph of the density of optical flow magnitude of said negative sample region; acquiring a density value of optical flow magnitude corresponding to the intersection point of said third distribution graph and said fourth distribution graph; and defining said acquired density value of optical flow magnitude as said third threshold value.
